(19) United States
(12) Patent Application Publication
(10) Pub. No.: US 2024/0338873 A1
(43) Pub. Date: Oct. 10, 2024

(54) INFORMATION PROCESSING DEVICE, INFORMATION PROCESSING METHOD, INFORMATION PROCESSING SYSTEM, COMPUTER PROGRAM, AND RECORDING MEDIUM

(71) Applicant: Sony Group Corporation, Tokyo (JP)

(72) Inventors: Ryo FUKAZAWA, Kanagawa (JP); Tomohiko GOTOH, Kanagawa (JP); Kazunori ASAYAMA, Tokyo (JP)

(73) Assignee: Sony Group Corporation, Tokyo (JP)

(21) Appl. No.: 18/574,570

(22) PCT Filed: Jun. 21, 2022
(86) PCT No.: PCT/JP2022/024647

§ 371 Date: Dec. 27, 2023

(30) Foreign Application Priority Data
Jul. 7, 2021 (JP) 2021-112998

(51) Int. Cl. G06T 13/40; G06F 3/01; G06T 7/70; G06T 19/20

(52) U.S. Cl. CPC G06T 13/40; G06F 3/013; G06T 7/70; G06T 19/20; G06T 2207/20044; G06T 2219/2004

(57) ABSTRACT

Provided is an information processing device capable of providing content with high added value. The information processing device according to an embodiment includes a motion control unit that changes a motion of an object in content on the basis of information about recognition by a user viewing the content of the content.

### TECHNICAL FIELD

The present disclosure relates to an information processing device, an information processing method, an information processing system, a computer program, and a computer-readable recording medium.

### BACKGROUND ART

With the progress and spread of virtual reality (VR) and sensing technology, distribution content using a character avatar (hereinafter, it is simply referred to as an avatar) is spreading. An example of the distribution content includes live content by the avatar as the performer. In such live content, a distribution method is also variously devised. As an example of interesting live content, recently, content was delivered in which an avatar as a 3D displayed performer performs a performance in a virtual space on an online game.

For example, an X-reality (XR) display such as a metaverse service provided by an online game, a head mount display (VR-HMD), and a spatial reproduction display (spatial reality display) is expected to become increasingly popular in the future. In the XR display, a character such as an avatar is 3D displayed in a virtual space, so that a sense of reality and a sense of immersion can be enhanced. With the spread of such XR displays, the field of distribution services such as live content using 3D displayed avatars is expected to become increasingly successful in the future.

### CITATION LIST

### Patent Document

Patent Document 1: Japanese Patent Application Laid-Open No. 2002-74838

### SUMMARY OF THE INVENTION

### Problems to be Solved by the Invention

The motion of the avatar played back in the current general live content is realized by an asset based on imaging by motion capture or an asset created in advance by a creator. Note that the asset means, for example, data including a plurality of bones constituting the avatar and sequence information for moving the bones. Then, an avatar of the same motion is usually played for all viewers.

For this reason, in the live content so far, for example, reaction of an avatar or the like is not performed in accordance with the movement of the viewer, and the live content is unidirectional content from the distributor to the viewer, and is poor in interactivity. That is, in general live content, the situation of the viewer is not taken into consideration, and content subjected to personalized process is not provided to the viewer.

In a real live show (concert), an interaction between a performer and an audience or a reaction to what happens on the spot occurs, which leads to provision or sharing of a sense of unity and a premium feeling of experience. Even in the live in the virtual space, it is considered that the content that attracts the viewer more can be provided by realizing such a bidirectional reaction.

Note that a technique for synthesizing motion by a combination of a plurality of types of motion data prepared in advance or synthesizing motion of a mouth according to a voice is already known. However, such known techniques only generate a motion synthesized in accordance with events or inputs occurring in games or the like. Therefore, such personalization processing that changes a motion according to the movement actually performed live by each viewer is not considered. Therefore, it is difficult to realize a bidirectional reaction close to real live.

Furthermore, the live content as described above may be distributed online in a virtual space that realizes multi-player multiplay. At this time, the number of simultaneous participants is not limited, but when distribution is performed from one server to a large number of client devices (viewers), a processing load increases. Therefore, in order to reduce the processing load, for example, a plurality of server instances corresponding to 100 viewers is generated on the server, and the client devices are distributed, so that distribution of the live content in which tens of thousands of people can participate may be realized.

In a case where a plurality of server instances is generated as described above, the load of content distribution can be reduced. However, since the same content (motion) is distributed via a plurality of server instances, it is difficult to perform an interaction or a reaction suitable for the viewer in real time even if the movement or the reaction of each viewer is fed back to the distribution side.

Furthermore, in a case where content is distributed from a server, it is conceivable that a lag of several seconds to several minutes occurs from distribution to content viewing due to data encoding/decoding, a calculation process at the time of content playback, and network delay. Such a lag can also be a barrier to realize interactive interaction or reaction in response to each viewer. Therefore, in a case where the provision of the personalized content is realized, there is also a concern about a distribution environment.

The present disclosure has been made in view of the above circumstances, and provides an information processing device, an information processing method, an information processing system, a computer program, and a recording medium capable of providing content with high added value.

### Solutions to Problems

An information processing device of the present disclosure includes a motion control unit that changes a motion of an object in content on the basis of information about recognition by a user viewing the content of the content.

An information processing method of the present disclosure includes acquiring information about recognition by a user viewing content of the content, and changing a motion of an object in the content on the basis of the information about recognition.

An information processing system of the present disclosure includes a server device and a client device that plays back content under control of the server device, in which at least one of the server device or the client device includes a motion control unit that changes a motion of an object in the content on the basis of information about recognition by a user viewing the content with the client device of the content.

A computer program of the present disclosure causes a computer to execute a step of changing a motion of an object in content on the basis of information about recognition by a user viewing the content of the content.

A recording medium of the present disclosure is a computer-readable recording medium recording a computer program for causing a computer to execute a step of changing a motion of an object in content on the basis of information about recognition by a user viewing the content of the content.

### BRIEF DESCRIPTION OF DRAWINGS

FIG. 1 is a diagram illustrating a configuration example of an information processing system according to a first embodiment.

FIG. 2 is a block diagram of a content data distribution device constituting the information processing system according to the first embodiment.

FIG. 3 is a block diagram of each of a server device and a client device constituting the information processing system according to the first embodiment.

FIG. 4 is a flowchart illustrating an example of an operation of the content data distribution device according to the first embodiment.

FIG. 5A is a front view of an object that reproduces a motion with object motion data created by the content data distribution device according to the first embodiment.

FIG. 5B is a side view of the object corresponding to FIG. 5A.

FIG. 5C is a top view of the object corresponding to FIG. 5A.

FIG. 6 is a side view of an object reproducing a motion different from those in FIGS. 5A to 5C.

FIG. 7 is a front view of an object that reproduces a motion different from those in FIGS. 5A to 5C and FIG. 6.

FIG. 8 is a diagram illustrating an example of a tolerance regarding a motion change set to an object in content.

FIG. 9 is a diagram illustrating an example of a tolerance regarding a motion change set to an object in content.

FIG. 10 is a diagram illustrating an example of a tolerance regarding a motion change set to an object in content.

FIG. 11 is a conceptual diagram illustrating motion change logic used when a motion of an object in content displayed on a client device is changed on the basis of information about recognition by a user of content.

FIG. 12 is a flowchart illustrating an example of an operation of the server device according to the first embodiment.

FIG. 13 is a flowchart illustrating an example of an operation of the client device according to the first embodiment.

FIG. 14 is a diagram illustrating an example of a state in which the client device according to the first embodiment displays content in a virtual space displayed on a display device.

FIG. 15 is a diagram illustrating an example of a post-change motion after changing a motion of an object in content on the basis of motion change logic.

FIG. 16 is a diagram for describing an example of a case where a post-change motion changed on the basis of the motion change logic is determined to be a failure.

FIG. 17 is a diagram for explaining an example of a post-change motion different from that in FIG. 15.

FIG. 18 is a view illustrating an example of a post-change motion which is different from that in FIG. 16 and is determined to be a failure.

FIG. 19 is a view for explaining an example of a post-change motion different from those in FIGS. 15 and 17.

FIG. 20 is a diagram illustrating an example of a post-change motion after changing a motion of each of a plurality of objects in content on the basis of motion change logic.

FIG. 21 is a view illustrating a modification of the first embodiment using a spatial reproduction display as a display device.

FIG. 22 is a view for describing a modification of the first embodiment using a head mounted display as a display device.

FIG. 23 is a block diagram of each of a content data distribution device, a server device, and a client device constituting an information processing system according to a second embodiment.

FIG. 24 is a flowchart illustrating an example of an operation of the server device according to the second embodiment.

FIG. 25 is a flowchart illustrating an example of an operation of the client device according to the second embodiment.

FIG. 26 is a diagram illustrating an example of a hardware configuration of an information processing device that can constitute the content data distribution device, the server device, and the client device according to the embodiment.

### MODE FOR CARRYING OUT THE INVENTION

Hereinafter, embodiments of the present disclosure will be described in detail with reference to the drawings. In one or more embodiments shown in the present disclosure, elements included in each of the embodiments can be combined with each other, and the combined result also forms part of the embodiments described in the present disclosure.

### First Embodiment

FIG. 1 illustrates a configuration example of an information processing system S1 according to a first embodiment. The information processing system S1 illustrated in FIG. 1 includes a content data distribution device 10, a server device 20, a plurality of client devices 30, and a plurality of display devices 31. The content data distribution device 10, the server device 20, and the client device 30 are connected to each other via a communication network 40, and can communicate bidirectionally.

The communication network 40 may be a wide area network such as the Internet or a local area network such as a wireless local area network LAN or Ethernet (registered trademark). The client device 30 is a device operated by a user. The client device 30 displays the content provided from the content data distribution device 10 or the server device 20 on the display device 31. At this time, the server device 20 performs control such that the content is played back at the same time in each client device 30, that is, played back in a multiplay manner.

In the present embodiment, various pieces of data for playing back content are provided in advance from the content data distribution device 10 to the client device 30. Then, the server device 20 controls the playback of the content in the client device 30 in response to the playback request from the client device 30. However, the present disclosure is not limited to such a playback method. Various pieces of data for playing back content may be provided from the server device 20 to the client device 30, for example, and may be provided particularly in real time.

Hereinafter, the content data distribution device 10, the server device 20, the client device 30, and the display device 31 constituting the information processing system S1 will be described.

### <Content Data Distribution Device>

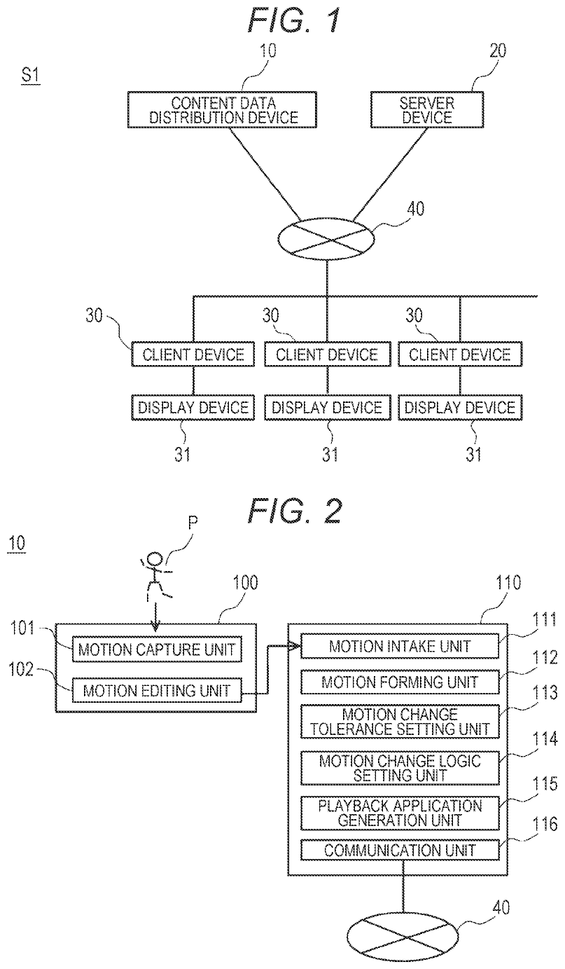

FIG. 2 illustrates a block diagram of the content data distribution device 10. The content data distribution device 10 is a device that generates and distributes various pieces of data, applications, and the like for playing back content. The content data distribution device 10 may be, for example, a device used by a content creator in a company or the like that provides a distribution service.

The content data distribution device 10 can be configured as hardware by an information processing device (computer) including a CPU, various storage devices, an input/output interface, and the like. In this case, various functions realized by the content data distribution device 10 can be realized by a computer program developed from a storage device.

The content data distribution device 10 illustrated in FIG. 2 includes a motion material acquisition unit 100 and a motion data generation unit 110. The motion material acquisition unit 100 and the motion data generation unit 110 may be configured by one information processing device. Alternatively, the motion material acquisition unit 100 and the motion data generation unit 110 may be configured by different information processing devices.

The motion material acquisition unit 100 includes a motion capture unit 101 and a motion editing unit 102. The motion data generation unit 110 includes a motion intake unit 111, a motion forming unit 112, a motion change tolerance setting unit 113, a motion change logic setting unit 114, a playback application generation unit 115, and a communication unit 116. These units can be realized by a computer program developed from a storage device.

As illustrated in FIG. 2, the motion capture unit 101 acquires, for example, a real motion at the time of performance of a performer P as a motion material of digital information by a motion capture technology. The motion capture technology to be used may be, for example, an optical system in which a plurality of markers attached to the performer is imaged by a plurality of imaging devices, an inertial sensor system in which an acceleration sensor is attached to the performer to analyze position information, a video analysis system in which a captured real motion of the performer is analyzed, or the like.

The motion material includes, for example, (1) a plurality of bones corresponding to the performer P connected via joints, (2) a body part including a polygon corresponding to a bone, (3) motion information (for example, sequence information or a so-called script) for reproducing motions of the bones according to the real motion of the performer P, (4) motion playback speed information, and the like. The motion information is information that defines the order of motion of an object that changes in time series. In the present embodiment, a plurality of bones and body parts corresponding thereto constitute an avatar of the performer P as an object. Hereinafter, a bone or a bone and a body part corresponding thereto may be referred to as an element object constituting an object.

The motion editing unit 102 edits the motion material described above acquired by the motion capture unit 101 in accordance with the operation of the creator or automatically. The edited content may be the shape, molding of the position, or correction of the object. In the motion material acquired by the motion capture unit 101, a situation in which the movement of a specific part of the performer P cannot be appropriately acquired by an imaging device or the like may occur. In such a case, the motion editing unit 102 performs editing such as making the movement of a specific part of the performer a natural movement. Then, the motion editing unit 102 provides the edited or original motion material to the motion data generation unit 110.

In the motion data generation unit 110, the motion intake unit 111 acquires the motion material described above from the motion editing unit 102 and provides the acquired motion material to the motion forming unit 112. The motion forming unit 112 forms the motion material provided from the motion intake unit 111 in response to an operation of the creator of the content or automatically.

Various editing processing functions for the motion material included in the motion data generation unit 110 may not be compatible with the motion material from the motion editing unit 102. In such a case, the motion forming unit 112 forms the motion material in a format that is easy to handle by the motion data generation unit 110. At least some of the various functions of the motion data generation unit 110 may be implemented by a versatile game engine. In such a case, a situation may occur in which compatibility between the motion material and the function of the motion data generation unit 110 is not good. At this time, the motion forming unit 112 forms the motion material, so that the processing can be efficiently performed.

The motion forming unit 112 generates the motion material described above as object motion data. The object motion data is basically the same data structure as the motion material, and includes (1) a plurality of bones, (2) body parts corresponding thereto, (3) motion information for reproducing motions of the bones according to the real motion of the performer P, (4) motion playback speed information, and the like.

The motion change tolerance setting unit 113 sets the tolerance of the change in motion for the object whose motion is reproduced by the object motion data described above. The setting of the tolerance in the motion change tolerance setting unit 113 is performed, for example, according to an operation of the creator of the content or automatically. Although details will be described later, in the present embodiment, when the object corresponding to the performer P in the content is displayed on the display device 31, the motion (strictly speaking, some motions in the overall motion) can be changed on the basis of the information about recognition by a user for the content displayed on the display device 31. The motion change tolerance setting unit 113 is used to set the tolerance related to such a change in motion in advance.

The tolerance is an index in which the higher the tolerance, the larger the change in motion is reflected, and the lower the tolerance, the more the influence of the change in motion is suppressed. The tolerance is set in a range of 0% to 100%, for example. A method of setting the tolerance is not particularly limited, but for example, the tolerance is set high for a motion with a low degree of importance, and the tolerance is set low for a motion with a high degree of importance. The motion with a low degree of importance may be, for example, an action in which the performer P is singing while walking on the stage, an action in which the performer P is simply walking on the stage, an action in which the performer P stands by between pieces of music, an action in which the performer P is silent, or the like. The motion of a high degree of importance may be a speech scene between songs, a scene of intense dancing, or the like. That is, the tolerance may be set to a different value according to a detail of the motion. That is, different tolerance values may be set for the object according to a detail of some motions in the overall motion.

Furthermore, in the present embodiment, the bone included in the object motion data, more specifically, the bone data includes a plurality of bones corresponding to the element object. In this case, the motion of the object is constituted by a combination of element motions set for respective bones, that is, respective element objects. In the present embodiment, the tolerance described above is defined for each element object as the tolerance regarding the change in the element motion. That is, the motion change tolerance setting unit 113 sets the tolerance for each element object. Note that the element motion includes, for example, a motion in which the element object relatively changes the posture with respect to the corresponding joint and/or a motion in which the state of each of the element objects changes (such as moving the mouth).

The motion change logic setting unit 114 creates a motion change logic in which the change pattern when changing the motion is defined on the basis of the information about recognition by the user as described above. The motion change logic setting unit 114 is used, for example, when the motion change logic is created in advance according to the operation of the creator of the content. The motion change logic is information that defines a relationship between the information about recognition by the user for the content and the change pattern of the motion corresponding to the information about recognition. The motion change logic is created as, for example, a table.

The information about recognition by the user is information detected by the client device 30, and is, for example, a position, a line-of-sight, a gesture, an operation of an operation unit, a combination thereof, or the like of the user. The change pattern is, for example, a change in the movement path of the object corresponding to the performer P toward the position of the user, a change in the direction of the head and the line-of-sight of the object toward the line-of-sight of the user, a change in which an action of the object such as smiling or waving a hand toward the user is added, or the like.

The motion change logic is developed to the client device 30, and is used when the client device 30 changes the motion of the object being played back on the basis of the information about recognition by a user for the content being played back by the client device 30.

Although details will be described later, in a case where the motion of the object is changed on the basis of the motion change logic, the client device 30 first determines a change pattern of the motion corresponding to the detected information about recognition. Then, after the change pattern is identified, the part of the element object to be changed is selected on the basis of the tolerance set for the object in the motion to be changed, and the degree of change based on the change pattern of the selected part is determined.

The process of selecting the part of the element object to be changed on the basis of the tolerance means a process of selecting a part, for example, the left hand having a high tolerance as the part where the motion is changed when, for example, the action of waving a hand is selected as the change pattern. In addition, the process of determining the degree of change of the part selected on the basis of the tolerance means a process of determining to perform the motion of the action of waving a hand with the movement reflecting 50% of the action of waving a hand defined by the change pattern, that is, the movement smaller than the action of waving a hand defined by the change pattern when the action of waving a hand is selected as the change pattern and the tolerance of the part to be changed is 50%.

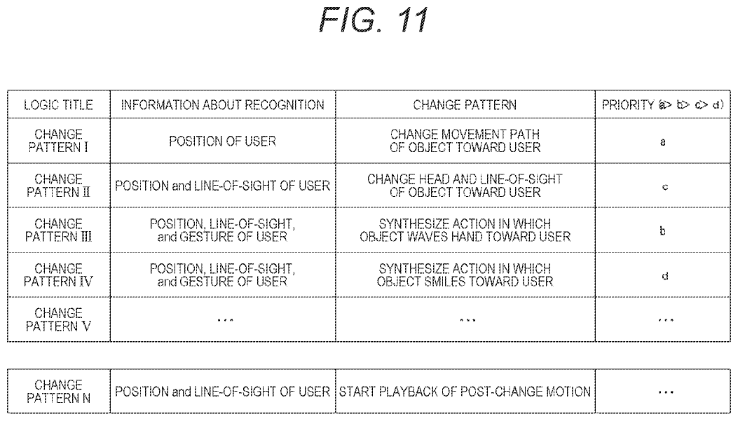

Furthermore, the information about recognition by a user for the content as described above can be simultaneously detected in a plurality of patterns. At this time, a situation in which the change patterns conflict with each other may occur. In consideration of such a situation, in the motion change logic in the present embodiment, a priority is set to the change pattern, and the change pattern is selected on the basis of the priority. The motion change logic setting unit 114 also sets such a priority. The above motion change logic will be described in detail with reference to FIG. 11 and the like.

The playback application generation unit 115 records the object motion data created as described above, the tolerance and the motion change logic set thereto, the data of the peripheral portion such as the stage for forming the content in cooperation with the object whose motion is played back by the object motion data and/or the object motion data of another object, and the server application and the client application created in advance. Then, the playback application generation unit 115 processes the server playback data to be provided to the server device 20 and the client playback data to be provided to the client device 30 on the basis of these pieces of information.

The server playback data includes a server application and at least motion information and playback speed information in the object motion data. The client playback data includes a client application, object motion data, a tolerance and motion change logic set thereto, data of the peripheral portion such as the stage for forming the content in cooperation with the object whose motion is played back by the object motion data, and/or object motion data of another object.

The server application is an application provided to the server device 20, and is used when the server device 20 controls playback of content in the client device 30. The server application includes a computer program for causing the server device 20 to implement a process and the like of determining motion information for reproducing a motion of an object in content and information about a playback timing of the motion played back by the motion information.

The client application is an application provided to the client device 30, and is used when the client device 30 plays back content on the display device 31 on the basis of a control signal from the server device 20. The client application includes a computer program for causing the client device 30 to implement a process of playing back content on the basis of a control signal received from the server device 20, a process of acquiring information about recognition by a user, a process of changing a motion of an object in the content on the basis of the information about recognition, and the like.

The communication unit 116 transmits the server application, the client application, or the like recorded or generated by the playback application generation unit 115 to the server device 20, the client device 30, or the like via the communication network 40.

The communication unit 116 transmits the server application to the server device 20 in response to a request from the server device 20. Furthermore, the communication unit 116 may transmit the client application, the object motion data, the tolerance and the motion change logic set thereto, and the like to, for example, the online store. In this case, the online store provides the client application, the object motion data, the tolerance and the motion change logic set thereto, and the like in response to a request from the client device 30.

However, a method of providing the application as described above is not particularly limited. For example, the client application or the like may be downloaded from a home page of a content distribution company, or may be provided to the user in a state of being recorded on a recording medium or in a state of being mounted on an information processing device.

### <Server Device>

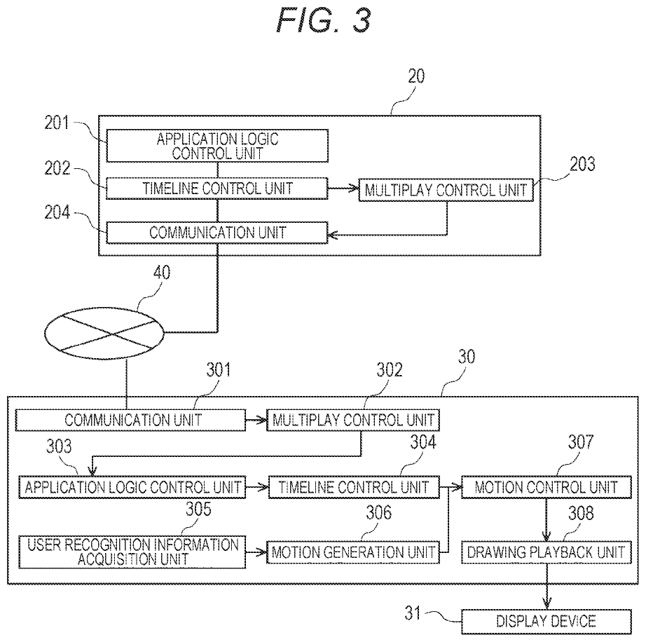

FIG. 3 illustrates a block diagram of the server device 20. The server device 20 is a device that controls playback of content in the client device 30 as described above. The server device 20 may be, for example, a server device of a company or the like that provides a distribution service. The server device 20 can be configured as hardware by an information processing device (computer) including a CPU, various storage devices, an input/output interface, and the like. In this case, various functions realized by the server device can be realized by a computer program developed from the storage device.

As illustrated in FIG. 3, the server device 20 includes an application logic control unit 201, a timeline control unit 202, a multiplay control unit 203, and a communication unit 204. Each of these units can be realized by a computer program developed from a storage device, and specifically, at least part of each of these units is realized by the above-described server application.

When the server device 20 receives a content playback request from the client device 30, the application logic control unit 201 determines motion information for reproducing a motion of an object in the content displayed on the client device 30. In the present embodiment, the application logic control unit 201 is realized by the above-described server application provided from the content data distribution device 10. In this case, the motion information determined by the application logic control unit 201 is defined on the basis of the motion information of the object provided to the server device 20 together with the server application.

When the application logic control unit 201 determines the motion information as described above, the timeline control unit 202 determines the playback timing information of the determined motion information. The playback timing information is a playback start timing of the motion information, a playback speed (switching speed of the frame rate), and the like. The timeline control unit 202 in the present embodiment is also realized by the server application, and the playback timing information determined by the timeline control unit 202 is defined on the basis of the playback speed information of the object provided to the server device 20 together with the server application.

As described above, in the present embodiment, the server device 20 performs control such that content is played back in multiplay in each client device 30. The multiplay control unit 203 is provided with the motion information determined by the application logic control unit 201, the playback timing information determined by the timeline control unit 202, and the like as described above, and generates a control signal for performing multiplay.

Specifically, when the server device 20 receives the playback request of the content from the plurality of client devices 30, the multiplay control unit 203 generates a control signal for causing the content displayed on each client device 30 to progress at the same timing. Here, the motion information determined by the application logic control unit 201 and the playback timing information determined by the timeline control unit 202 are processed as part of the control signal for playing back the content.

Furthermore, the information processing system S1 according to the present embodiment displays content in a virtual space in which an avatar operated by the user of the client device 30 exists. In this case, avatars of the users of the plurality of client devices 30 are displayed in the virtual space. Here, the multiplay control unit 203 also generates a signal for displaying such an avatar of each user in the virtual space as part of the control signal.

The control signal for playing back the content generated by the multiplay control unit 203 includes, in addition to the signal corresponding to the motion information described above, the signal corresponding to the playback timing information, and the signal for displaying the avatar, a signal corresponding to data for playing back a peripheral portion forming the content together with the object, a signal related to sound information, and the like. The multiplay control unit 203 provides each client device 30 with such a control signal at the same timing, so that the server device 20 implements to display the content and the avatar of each user in multiplay in each client device 30.

The communication unit 204 receives the control signal described above from the multiplay control unit 203, for example, and transmits the control signal to each client device 30 via the communication network 40. The communication unit 204 may encode the control signal to transmit the signal to the client device 30. Furthermore, the communication unit 204 is also used when receiving a server application. Note that, in the present embodiment, the application logic control unit 201 and the timeline control unit 202 are implemented by a server application, but the multiplay control unit 203 may be further implemented by a server application. However, a method of embodying the application logic control unit 201, the timeline control unit 202, and the like is not particularly limited.

### <Client Device>

The client device 30 is a device that displays content on the display device 31 under the control of the server device 20 as described above. The client device 30 can be configured as hardware by an information processing device (computer) including a CPU, various storage devices, an input/output interface, and the like. In this case, various functions realized by the server device can be realized by a computer program developed from the storage device.

FIG. 3 also illustrates a block diagram of the client device 30. The client device 30 includes a communication unit 301, a multiplay control unit 302, an application logic control unit 303, a timeline control unit 304, a user recognition information acquisition unit 305, a motion generation unit 306, a motion control unit 307, and a drawing playback unit 308. Each of these units can be realized by a computer program developed from a storage device, and specifically, at least part of each of these units is realized by the client application described above.

In the present embodiment, prior to the playback of the content, the client device 30 receives various pieces of data such as a client application, object motion data, a tolerance and motion change logic set thereto, data of the peripheral portion such as the stage for forming the content in cooperation with the object whose motion is played back by the object motion data, and/or object motion data of another objects. At this time, the communication unit 301 receives the above-described various pieces of data from the content data distribution device 10 via the communication network 40. Furthermore, when playing back the content in the client device 30, the communication unit 301 transmits a content playback request to the server device 20. Furthermore, the communication unit 301 receives a control signal for playing back content transmitted by the server device 20 in response to the playback request.

When the communication unit 301 receives the control signal described above from the server device 20, the multiplay control unit 302 receives the control signal from the communication unit 301. At this time, the multiplay control unit 302 transmits, to the application logic control unit 303, a signal corresponding to motion information for reproducing a motion of an object among the control signals. Furthermore, the multiplay control unit 302 transmits a signal corresponding to the playback timing information to the timeline control unit 304. Furthermore, the multiplay control unit 302 transmits, to the drawing playback unit 308, other signals, for example, a signal corresponding to data for playing back a peripheral portion forming content together with an object, a signal for displaying an avatar corresponding to another user, a signal related to sound information, and the like.

The application logic control unit 303 receives a signal corresponding to the motion information from the server device 20 described above from the multiplay control unit 302, and determines motion information for reproducing the motion of the object in the content on the basis of the signal. The timeline control unit 304 receives a signal corresponding to the playback timing from the server device 20 described above from the multiplay control unit 302 as described above, and determines the playback timing of the motion information determined by the application logic control unit 303 on the basis of the signal. The playback timing is a playback start timing, a playback speed (switching speed of a frame rate), and the like.

The basic motion of the object in the content is determined by the motion information determined by the application logic control unit 303 and the playback timing determined by the timeline control unit 304 described above. The application logic control unit 303 transmits the determined motion information to the motion control unit 307, and the timeline control unit 304 transmits the determined playback timing to the motion control unit 307. Furthermore, in a case where the control signal from the server device 20 includes a signal corresponding to the motion information and the playback timing information of another object, the application logic control unit 303 and the timeline control unit 304 also determine the motion information and the playback timing regarding the another object, and transmit the motion information and the playback timing to the motion control unit 307.

Although details will be described later, the motion control unit 307 determines whether or not to reproduce the motion of the object in the content by the motion information from the application logic control unit 303 or to reproduce the motion by changing this motion information on the basis of the information about recognition detected by the user recognition information acquisition unit 305. In the case of changing the motion, the motion generation unit 306 generates replacement motion information to be described later on the basis of the information about recognition detected by the user recognition information acquisition unit 305, and the replacement motion information is reflected in the motion information determined by the application logic control unit 303.

The user recognition information acquisition unit 305 functions together with playback of the content, and acquires information about recognition, of the content, by the user who is viewing the content. As described above, the information about recognition by the user is, for example, a position, a line-of-sight, a gesture, an operation of an operation unit, a combination thereof, and the like of the user. In the present embodiment, content is displayed in a virtual space in which an avatar operated by the user of the client device 30 exists. In a case where the content is displayed in the virtual space in this manner, the user recognition information acquisition unit 305 detects, as the position of the user, a relative position between the object in the content displayed in the virtual space and the avatar operated by the user. Furthermore, the user recognition information acquisition unit 305 detects the line-of-sight of the avatar operated by the user as the line-of-sight of the user. Furthermore, the user recognition information acquisition unit 305 detects a gesture of an avatar operated by the user as the gesture of the user.

Note that, in a case where the display device 31 is a head mounted display, content may be displayed in a virtual space or an augmented reality space directly viewed by the user. In this case, the user recognition information acquisition unit 305 detects, as the position of the user, the relative position between the object and the viewpoint of the user on the basis of the position of the head mounted display. Furthermore, the user recognition information acquisition unit 305 detects the posture of the head mounted display and/or the line-of-sight of the user as the line-of-sight of the user by an internal sensor. Furthermore, the user recognition information acquisition unit 305 detects a gesture by a sensor attached to an arm or the like by the user while wearing the head mounted display, as the gesture of the user. Furthermore, in a case where the display device 31 is a spatial reproduction display (spatial reality display), the content is three-dimensionally displayed on the spatial reproduction display. In this case, the user's face can be detected by a sensor attached to the spatial reproduction display. In this case, the user recognition information acquisition unit 305 may detect the position, the line-of-sight, and the gesture of the user from the detection information of the sensor.

In a case where the user recognition information acquisition unit 305 detects the information about recognition as described above, the motion generation unit 306 receives the information about recognition from the user recognition information acquisition unit 305. Then, the motion generation unit 306 generates replacement motion information in which the motion information of the object is changed on the basis of the information about recognition and the motion change logic. Specifically, at this time, the motion generation unit 306 first identifies the change pattern on the basis of the information about recognition and the motion change logic. Next, the motion generation unit 306 changes the motion information (in the present embodiment, part of the motion information) of the object in the content after the information about recognition is detected on the basis of the change pattern, thereby generating the replacement motion information.

More specifically, after the change pattern is identified, the motion generation unit 306 selects part of the element object to be changed on the basis of the tolerance set for the object in the motion to be changed. Next, the motion generation unit 306 changes the element motion information of the selected element object on the basis of the change pattern, and generates replacement motion information different from motion information defining the basic motion.

The motion control unit 307 receives the motion information determined by the application logic control unit 303 and the playback timing determined by the timeline control unit 304 as described above, and receives the post-change motion information from the motion generation unit 306 in a case where the post-change motion information is generated by the motion generation unit 306. Then, on the basis of the received information, the motion control unit 307 determines whether or not to reproduce the motion of the object in the content with the motion information from the application logic control unit 303 or to reproduce the motion by changing the motion information on the basis of the information about recognition detected by the user recognition information acquisition unit 305.

Specifically, in a case where only the motion information determined by the application logic control unit 303 and the playback timing determined by the timeline control unit 304 are received, the motion control unit 307 determines to reproduce the motion of the object in the content with the motion information determined by the application logic control unit 303. In this case, the motion control unit 307 provides the drawing playback unit 308 with the motion information determined by the application logic control unit 303 as it is.

On the other hand, in a case where receiving the motion information determined by the application logic control unit 303 and the playback timing determined by the timeline control unit 304, and the replacement motion information, the motion control unit 307 generates the post-change motion information in which the replacement motion information is reflected in the motion information determined by the application logic control unit 303.

When the post-change motion information is generated, the extent to which the replacement motion information is reflected in the motion information determined by the application logic control unit 303 is determined on the basis of the tolerance. For example, when the action of waving a hand is selected as the change pattern, replacement motion information corresponding to the action of waving a hand defined by the change pattern is generated. Here, in a case where the tolerance of the element object to be changed is 50%, information in which 50% of the replacement motion information is reflected in the motion information determined by the application logic control unit 303 is generated as the post-change motion information.

However, in a case where the post-change motion information is generated as described above, the motion control unit 307 determines whether or not the post-change motion of the object reproduced by the post-change motion information exceeds a predetermined allowable motion range. The case where the post-change motion exceeds the allowable motion range includes, for example, a situation where an object floats and walks in the air outside the stage in a motion where the object walks on the stage, a situation where the object moves beyond the range of motion of the joint, and the like. The allowable motion range means a range of walking on the stage, a range of motion of a limit of the body, and the like.

Then, in a case where it is determined that the post-change motion does not exceed the allowable motion range, the motion control unit 307 provides the drawing playback unit 308 with the post-change motion information. On the other hand, in a case where it is determined that the post-change motion exceeds the allowable motion range, the motion is not changed or the post-change motion is corrected. The correction may be processed by, for example, inverse kinematics (IK) incorporated in the application.

In the present embodiment, in a case where it is determined that the post-change motion exceeds the allowable motion range, the motion control unit 307 corrects the post-change motion and then determines whether or not the corrected post-change motion exceeds the allowable motion range. Then, in a case where it is determined that the corrected post-change motion does not exceed the allowable motion range, the motion control unit 307 provides the drawing playback unit 308 with the post-change motion information. On the other hand, in a case where it is determined that the corrected post-change motion exceeds the allowable motion range, the motion control unit 307 determines not to change the motion, and provides the drawing playback unit 308 with the motion information from the application logic control unit 303 as it is.

The drawing playback unit 308 receives, from the motion control unit 307, the motion information determined by the application logic control unit 303 or the post-change motion information generated by the motion control unit 307 and the playback timing determined by the timeline control unit 304. Then, the drawing playback unit 308 performs a process (rendering) such that an object of motion in accordance with the received information is displayed on the display device 31. At this time, in a case where receiving a signal corresponding to data for playing back a peripheral portion forming content together with, for example, an object provided from the multiplay control unit 302, a signal for displaying an avatar corresponding to another user, and a signal related to sound information, the drawing playback unit 308 also performs a process (rendering) of displaying content components and the like based on these signals.

### <Display Device>

As illustrated in FIGS. 1 and 3, the display device 31 is electrically connected to the client device 30, and displays the virtual space and the content by the process of the drawing playback unit 308 of the client device 30 described above. The content including an object and the like is displayed on the display device 31, and the user can view the content. At this time, in the present embodiment, as described above, the motion of the object can be changed according to the information about recognition by a user for the content. As a result, the user can obtain interactivity in the content.

The display device 31 may be a liquid crystal display (LCD), an organic electroluminescence display, a plasma display panel (PDP), a head-up display, a spatial reproduction display, or the like. In the present embodiment, as an example, an aspect is assumed in which the display device is an LCD and content is displayed in a virtual space displayed on the LCD. Note that the client device 30 may be built in the display device 31, or may be connected to the client device 30 in a wired or wireless manner as a device different from the display device 31.

### <Operation of Each Unit of Information Processing System>

Hereinafter, operations of the content data distribution device 10, the server device 20, and the client device 30 will be described.

### (Operation of Content Data Distribution Device)

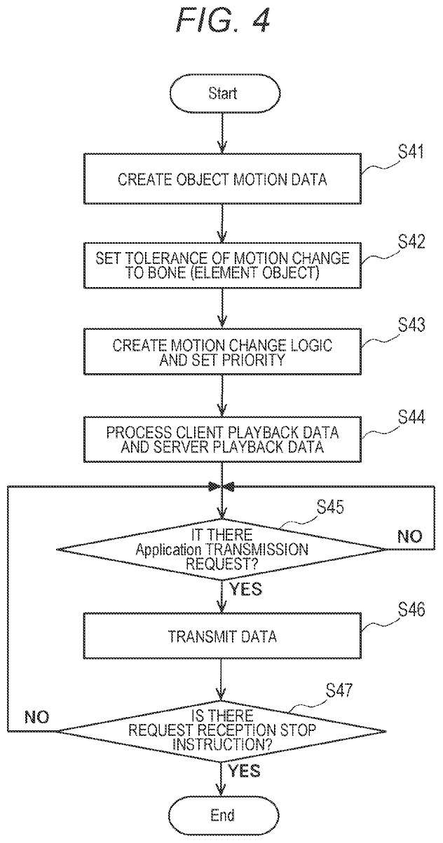

FIG. 4 is a flowchart illustrating an example of the operation of the content data distribution device 10. Hereinafter, an example of an operation of the content data distribution device 10 will be described with reference to FIGS. 2 and 4.

As illustrated in FIG. 4, the content data distribution device 10 first creates object motion data (S41). The object motion data is created with the motion material acquired by the motion capture unit 101 through the motion editing unit 102, the motion intake unit 111, and the motion forming unit 112.

After the object motion data is created, the content data distribution device 10 sets the tolerance of the change in motion for the object whose motion is reproduced by the object motion data (S42). This setting is performed by the motion change tolerance setting unit 113. In the present embodiment, specifically, the tolerance is set for each bone (element object) constituting the object. Furthermore, the tolerance is set to a different value according to a detail of the motion that changes in time series.

After the tolerance is set, the content data distribution device 10 creates the motion change logic, and sets a priority to the change pattern defined in the motion change logic (S43). This process is performed by the motion change logic setting unit 114.

After the motion change logic is created, the content data distribution device 10 processes the server playback data to be provided to the server device 20 and the client playback data to be provided to the client device 30 (S44). This process is performed by the playback application generation unit 115. As described above, the server playback data includes the server application and at least the motion information and the playback speed information in the object motion data. The client playback data includes a client application, object motion data, a tolerance and motion change logic set thereto, data of the peripheral portion such as the stage for forming the content in cooperation with the object whose motion is reproduced by the object motion data, and/or object motion data of another object.

Thereafter, the content data distribution device 10 monitors the presence or absence of an application transmission request from the server device 20, the client device 30, the online store, or the like (S45). Then, in a case where there is a transmission request, the server playback data is transmitted to the server device 20, or the client playback data is transmitted to the client device 30 directly or via an online store or the like (S46). Then, in this example, in a case where the request reception stop instruction is received during the monitoring of the presence or absence of the transmission request (YES in S47), the process of the content data distribution device 10 ends.

### (Concept of Object Motion Data)

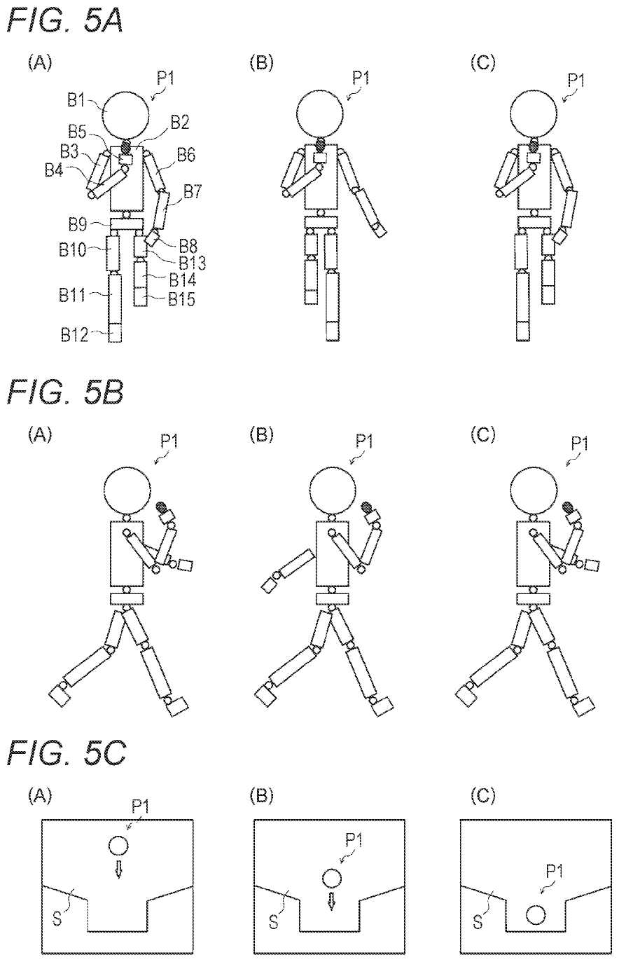

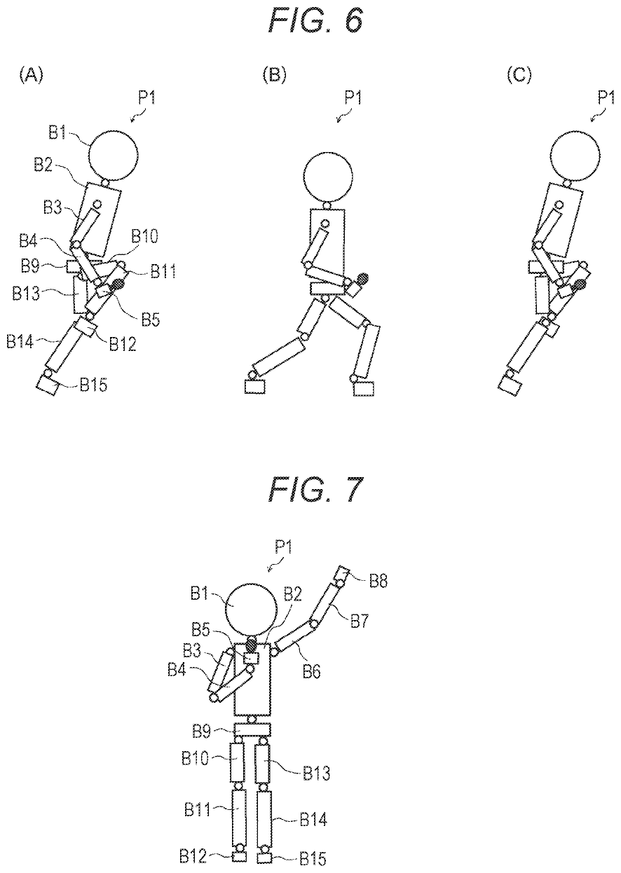

A specific image of the object motion data created in step 41 is described below. FIGS. 5A to 5C are respectively a front view, a side view, and a top view of an object that reproduces a motion by object motion data created by the content data distribution device 10. FIG. 6 is a side view of an object reproducing a motion different from that of FIGS. 5A to 5C. FIG. 7 is a front view of an object reproducing still different motion.

The object motion data created by the content data distribution device 10 includes a plurality of bones, body parts corresponding thereto, motion information for reproducing motions of the bones according to the real motion of the performer P, motion playback speed information, and the like. Here, reference numerals B1 to B15 in FIG. 5A (A) correspond to a plurality of bones (element objects). The object motion data is data for displaying an object with a predetermined motion as illustrated in FIGS. 5A to 7 by moving the bones B1 to B15 according to motion information or the like. Note that the bones B1 to B15 are appropriately omitted in FIGS. 5A to 5C, 6, and 7 for ease of illustration.

FIGS. 5A to 5C illustrate a state in which a motion in which an object P1 of the performer is singing while walking on the object corresponding to the stage S is reproduced in the order of (A)→(B)→(C). The motion information for reproducing such a motion includes setting, at appropriate positions of the plurality of bones B1 to B15, element motion information for reproducing the action of alternately moving the foot forward and backward, element motion information for reproducing the action of repeatedly moving the left hand forward and backward, element motion information for reproducing the action corresponding to the mouth during singing, and the like.

FIG. 6 illustrates a state in which the motion in which the object P1 of the performer is dancing is reproduced in the order of (A)→(B)→(C). The motion information for reproducing such motion includes setting, at appropriate positions of the plurality of bones B1 to B15, element motion information for reproducing the action of alternately moving the legs back and forth, element motion information for reproducing the action of moving the arms up and down, and the like. FIG. 7 illustrates how motion in which the object P1 of the performer is speaking is reproduced. The motion information for reproducing such motion includes element motion information for reproducing an action corresponding to a mouth during singing, and the like. Then, the overall motion information of the object includes concatenation of the motion information as described above.

The object motion data created in step S41 described above is created as data including, for example, the plurality of bones B1 to B15 described above, body parts corresponding thereto, motion information including element motion set for the bones B1 to B15, and motion playback speed information. In a case where a plurality of objects is displayed in the content, a plurality of pieces of object motion data corresponding to respective objects is created.

### (Concept of Tolerance Setting)

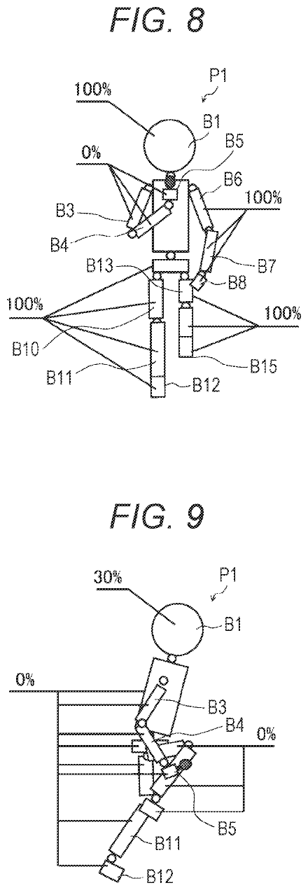

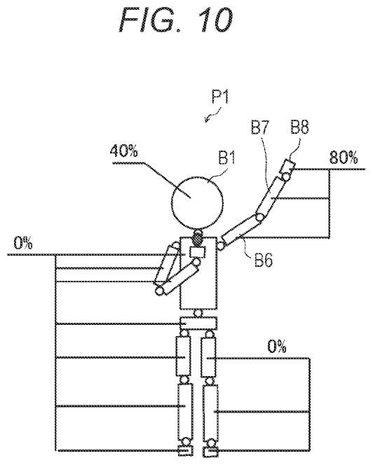

The following description is a description of a specific image of the tolerance setting performed in step 42. Each of FIGS. 8 to 10 is a diagram illustrating an example of the tolerance regarding the motion change set to the object. FIG. 8 illustrates an example of the tolerance set for the object P1 that reproduces the motion illustrated in FIGS. 5A to 5C. FIG. 9 illustrates an example of the tolerance set for the object P1 that reproduces the motion illustrated in FIG. 6. FIG. 10 illustrates an example of the tolerance set for the object P1 that reproduces the motion illustrated in FIG. 7.

FIG. 8 illustrates a motion in which an object P1 is singing while walking on an object corresponding to the stage S. In this motion, changing the movement of the right hand gripping the microphone may impair natural performance. Therefore, a low tolerance (0%) is set for the bones B3, B4, and B5, which are element objects of the right hand. On the other hand, the left hand can be said to be a motion with a low degree of importance. Therefore, a high tolerance (100%) is set for the bones B6, B7, and B8 which are element objects of the left hand. In addition, it can be said that a large problem does not occur even if the movement path of the object P1 is changed. Therefore, a high tolerance (100%) is set for the bones B10 to B15 corresponding to the foot.

FIG. 9 illustrates a motion in which the object P1 is dancing. In this motion, for example, changing the movement of the part below the head may impair natural performance. Therefore, a low tolerance (0%) is set for the bones B2 to B15 located below the bone B1 corresponding to the head. On the other hand, when the bone B1 corresponding to the head is not greatly changed, it can be said that natural performance is not impaired. Therefore, a tolerance of 30% is set for the bone B1 corresponding to the head.

FIG. 10 shows the motion in which the object P1 is speaking. In this motion, changing the movement of the right hand gripping the microphone may impair natural performance. Therefore, a low tolerance (0%) is set for the bones B3, B4, and B5, which are element objects of the right hand. Furthermore, a sudden start of walking from a state of speaking without moving may impair natural performance. Therefore, a low tolerance (0%) is set for the bones B10 to B15 corresponding to the foot. On the other hand, a tolerance of 30% is set such that the change is allowed to the bone B1 corresponding to the head but is not allowed to be large. In addition, since the left hand has a high degree of freedom, a high tolerance (80%) is set for the bones B6, B7, and B8 which are element objects of the left hand.

In the process of step S42 described above, for example, the tolerance is set for each of the bones B1 to B15 as described above. In a case where a plurality of objects is displayed in the content, the tolerance corresponding to each object is set. Furthermore, in a case where the object motion data is delivered in real time, the tolerance may be automatically set. In this case, the motion change tolerance setting unit 113 may analyze the movement of the object motion data and sequentially set the tolerance on the basis of a predetermined standard.

### (Concept of Motion Change Logic)

The following description is a description of a specific image of creating the motion change logic performed in step 43. FIG. 11 is a conceptual diagram illustrating the motion change logic. “Logic title” in FIG. 11 indicates a type of a change pattern. “Information about recognition” indicates a type of information about recognition corresponding to the change pattern. “Change pattern content” indicate change content of the motion. “Priority” indicates a priority set for each change pattern.

In the example of the motion change logic illustrated in FIG. 11, the change pattern I defines logic for changing the movement path of the object toward the user in a case where the position of the user is detected as the information about recognition.

The change pattern II defines logic for changing the head and the line-of-sight of the object toward the user in a case where the position of the user is detected as the information about recognition.

The change pattern III defines logic for synthesizing an action in which the object waves a hand toward the user in a case where the position, the line-of-sight, and the gesture of the user are detected as the information about recognition.

The change pattern IV defines logic for synthesizing an action in which the object smiles toward the user in a case where the position, the line-of-sight, and the gesture of the user are detected as the information about recognition.

In addition, the change pattern N defines logic for starting the post-change motion in a case where the position and the line-of-sight of the user are detected as the information about recognition.

In a case where the motion change logic as described above is created, in a case where, for example, the position of the user is detected as the information about recognition by the user viewing the content with the client device 30, display for changing the movement path of the object toward the user is possible (change pattern I). Furthermore, in a case where, for example, the position and the line-of-sight of the user are detected as the information about recognition, display for changing the head and the line-of-sight of the object toward the user is possible (change pattern II).

Furthermore, in the example of the motion change logic illustrated in FIG. 11, a tolerance a is set to the change pattern I, a tolerance c is set to the change pattern II, a tolerance b is set to the change pattern III, and a tolerance d is set to the change pattern IV (a>b>c>d). In the example of the motion change logic illustrated in FIG. 11 in a case where, for example, the position and the line-of-sight of the user are detected as the information about recognition, the change pattern I and the change pattern II can be selected. The priority is set in order to determine a change pattern to be selected in such a conflict state. That is, in this example, since the priority a is larger than the priority c, the change pattern I is selected.

Furthermore, the change pattern N is logic for adjusting the start timing of the post-change motion. For example, in a case where the position of the user is detected as the information about recognition and the change pattern is selected, the post-change motion information for reproducing the post-change motion is created on the basis of the change pattern (motion generation unit 306). At this time, the user may remove the line-of-sight from the object after the information about recognition is detected, and then turn the line-of-sight to the object again. The change pattern N is for performing control not to start the post-change motion in a case where the user takes the line-of-sight off from the object, but to start the post-change motion in a case where the user again directs the line-of-sight at the object.

In the process of step S43 described above, for example, the motion change logic described above is created. Note that, as described above, in a case where content is distributed in real time, the tolerance may be automatically set. On the other hand, even in a case where the content is distributed in real time, the motion change logic described above is desirably provided to the client device 30 in advance before the content is played back. In the present embodiment, it is assumed that the change based on the change pattern defined by the motion change logic is performed by changing the sequence information and the description of the motion information including the script. However, in addition to such a method, the change pattern may be configured as separately imaged object motion data, and the motion change may be performed by replacing this data.

When the motion change logic is created as described above, the motion change logic is processed as client playback data together with the object motion data created in step S41, the tolerance set in step S42, the client application, and the like. After being provided with the client playback data, the client device 30 transmits a content playback request to the server device 20 and waits for a control signal from the server device 20. Then, after the server device 20 transmits the control signal to the client device 30, the display of the content with the client device 30 is started.

### (Operation of Server Device)

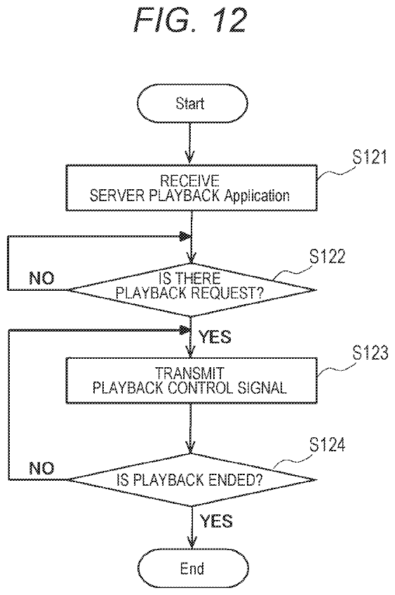

FIG. 12 is a flowchart illustrating an example of the operation of the server device 20. Hereinafter, an example of the operation of the server device 20 will be described.

As illustrated in FIG. 12, after receiving the server playback application (data) (S121), the server device 20 waits for a content playback request from the client device 30 (S122). Then, in a case where the playback request is received (YES in S122), it transmits a control signal for content playback to the client device 30 (S123). Then, the server device 20 transmits the control signal until receiving the playback end instruction signal, and ends the process in a case where receiving the playback end instruction signal (S124).

The control signal for content playback is generated by the multiplay control unit 203, and is generated on the basis of the information from the application logic control unit 201 and the timeline control unit 202 as described above. The control signal for playing back content includes a signal corresponding to motion information, a signal corresponding to playback timing information, a signal for displaying avatars (avatars of the user and another user), a signal corresponding to data for playing back a peripheral portion forming content together with an object, a signal related to sound information, and the like. The server device 20 provides each client device 30 with such a control signal at the same timing (S123), thereby implementing to display the content and the avatar of each user in multi-play in each client device 30.

### (Operation of Client Device)

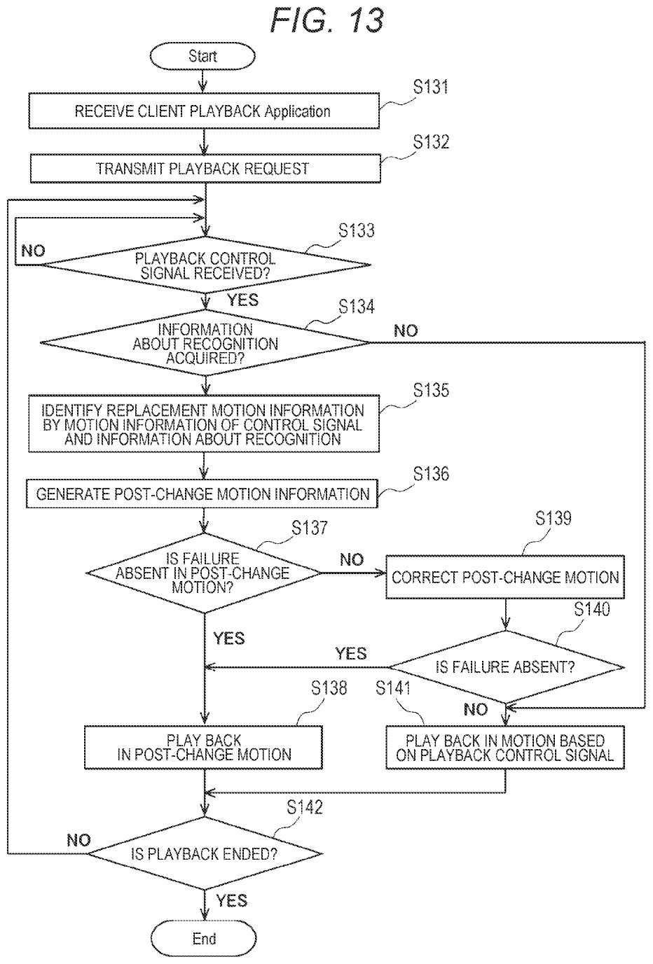

Hereinafter, an example of the operation of the client device 30 will be described with reference to the flowchart of FIG. 13. As illustrated in FIG. 13, after receiving the client playback application (data) (S121) and transmitting a content playback request to the server device 20 (S132), the client device 30 waits for a control signal from the server device 20 (S133).

In a case where the client device 30 receives the control signal from the server device 20, a signal corresponding to the motion information for reproducing the motion of the object among the control signals is transmitted to the application logic control unit 303, and a signal corresponding to the playback timing information is transmitted to the timeline control unit 304. Furthermore, other signals, for example, a signal corresponding to data for playing back a peripheral portion forming content together with an object, a signal for displaying an avatar corresponding to another user, a signal related to sound information, and the like are transmitted to the drawing playback unit 308. The signal transmission process described above is performed by the multiplay control unit 302.

After the process in step S133, the client device 30 monitors whether or not the information about recognition by the user is acquired by the user recognition information acquisition unit 305 (S134). Here, in a case where the information about recognition is not acquired (NO in S134), the object is played back in the basic motion of the object determined by the motion information determined by the application logic control unit 303 and the playback timing determined by the timeline control unit 304 on the basis of the control signal from the server device 20 (S141).

On the other hand, in a case where the information about recognition is acquired (YES in S134), the client device 30 selects the change pattern on the basis of the information about recognition and the motion change logic, and generates the replacement motion information in which the motion information of the object is changed on the basis of the change pattern (S135). The motion information to be changed is identified on the basis of the motion information determined by the application logic control unit 303. The replacement motion information is generated by changing motion information (in the present embodiment, part of the motion information) of the object in the content after the information about recognition is detected on the basis of the change pattern. Note that the generation process of the replacement motion information is performed by the motion generation unit 306. The replacement motion information generated in this manner is transmitted to the motion control unit 307. At this time, the motion information determined by the application logic control unit 303 and the playback timing determined by the timeline control unit 304 are also transmitted to the motion control unit 307 on the basis of the control signal from the server device 20.

When the replacement motion information is transmitted to the motion control unit 307 as described above, the client device 30 causes the motion control unit 307 to generate the post-change motion information in which the replacement motion information is reflected in the motion information determined by the application logic control unit 303 (S136). As described above, when the post-change motion information is generated, the extent to which the replacement motion information is reflected in the motion information determined by the application logic control unit 303 is determined on the basis of the tolerance.

After the post-change motion information is generated as described above, the client device 30 determines whether or not there is a failure in the post-change motion of the object reproduced by the post-change motion information (S137). The determination of the presence or absence of the failure is performed by determining whether or not the post-change motion exceeds a predetermined allowable motion range. As described above, the case where the post-change motion exceeds the allowable motion range includes, for example, a situation where an object floats and walks in the air outside the stage in a motion where the object walks on the stage, a situation where the object moves beyond the range of motion of the joint, and the like.

In a case of non-failure determination (YES in S137), the client device 30 plays back the object in the post-change motion determined by the post-change motion information and the playback timing determined by the timeline control unit 304 (S138). The content playback process is performed by the drawing playback unit 308.

On the other hand, in a case of failure determination (NO in S137), the client device 30 corrects the post-change motion (S139), and then, determines whether or not the corrected post-change motion exceeds the allowable motion range (S140). Here, in a case of non-failure determination (YES in S140), the client device 30 plays back the object with the corrected post-change motion (S138). The content playback process is performed by the drawing playback unit 308.

Furthermore, in a case where it is determined that the corrected post-change motion exceeds the allowable motion range (NO in S140), the client device 30 determines not to change the motion, and provides the drawing playback unit 308 with the motion information from the application logic control unit 303 as it is. I this case, on the basis of the control signal from the server device 20, the object is played back in the basic motion of the object determined by the motion information determined by the application logic control unit 303 and the playback timing determined by the timeline control unit 304 (S141).

After the process of steps S138 and S141, the client device 30 continuously receives the control signal from the server device 20. Then, until there is a playback end command (YES in S142), the client device 30 repeats a process of determining whether or not to reproduce the motion of the object in the content by the motion information from the application logic control unit 303 or to reproduce the motion by changing the motion information on the basis of the information about recognition detected by the user recognition information acquisition unit 305.

### (Example of Motion to be Changed)

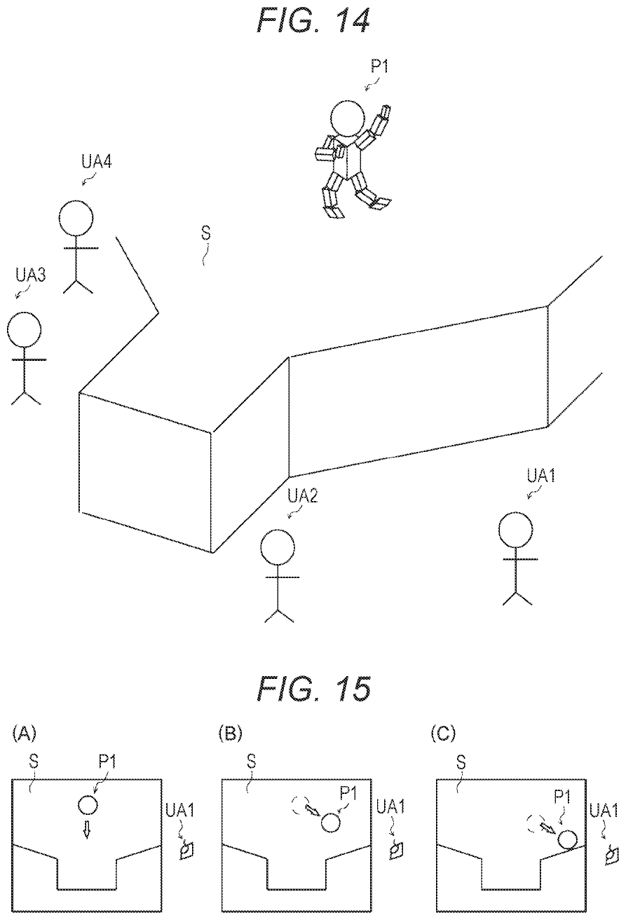

Hereinafter, an example of the motion change performed by the client device 30 will be specifically described with reference to FIGS. 14 to 20. First, FIG. 14 is a diagram illustrating an example of a state in which content is displayed in a virtual space displayed on the display device 31. In the virtual space illustrated in FIG. 14, the object P1 as an avatar as the performer is located on the stage S displayed in the virtual space. User avatars UA1 to 4 operated by the user of the client device 30 is displayed below the stage S. The state illustrated in FIG. 14 is a state before the motion described in FIGS. 5A to 5C is performed. The following example 1 to 3 is an example in which the motion of the object P1 is changed after the object P1 is displayed in the state of FIG. 14.

### (Example 1) Change in Movement Path

In a case where motion is reproduced by motion information based on a control signal from the server device 20, the object P1 illustrated in FIG. 14 walks toward the stage S while singing as illustrated in FIGS. 5A to 5C. Under such a situation, in a case where the position of the user avatar UA1 illustrated in FIG. 15(A) is detected, the client device 30 can generate the post-change motion in which the object P1 walks toward the user avatar UA1 as illustrated in FIGS. 15(A) to (C) by the motion generation unit 306 and the motion control unit 307 (S133 to $138). Such post-change motion is generated on the basis of the change pattern I illustrated in FIG. 11. In this post-change motion, since the walking range of the object P1 is within the stage S, no failure occurs. In this case, the client device 30 may adopt the post-change motion.

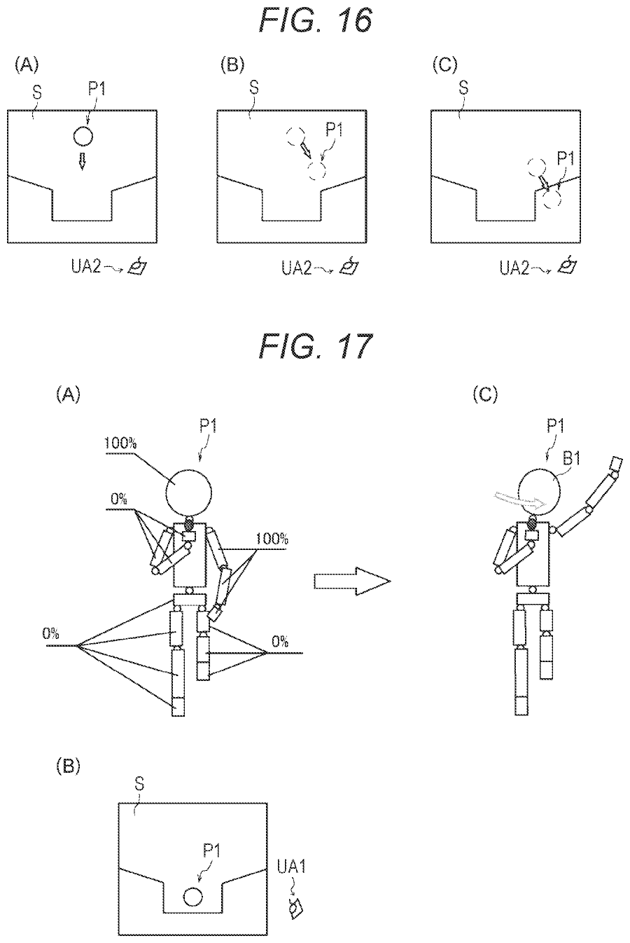

On the other hand, in a case where the position of the user avatar UA2 is detected as illustrated in FIG. 16(A), the client device 30 attempts to generate the post-change motion in which the object P1 walks toward the user avatar UA2 as illustrated in FIGS. 16(A) to (C) by the motion generation unit 306 and the motion control unit 307 (S133 to S136). However, in this post-change motion, since the walking range of the object P1 exceeds the stage S, a failure occurs (NO in S137). In such a case, the client device 30 does not adopt the post-change motion.

### (Example 2) Change 1 in Head and Line-of-Sight

The object P1 illustrated in FIG. 17 corresponds to the state in FIGS. 5A (C), 5B (C), and 5C (C). That is, the object P1 in FIG. 17 has reached the leading end of the stage S. At this time, as illustrated in FIG. 17(A), the tolerance of the object P1 is changed from that in the state during walking. Specifically, since it is difficult to change the movement path, a low tolerance (0%) is set for the bone related to the foot. On the other hand, a high tolerance (100%) is maintained for the bone B1 corresponding to the left hand and the head.

In a case where the position and the line-of-sight of the user avatar UA1 are detected under the situation illustrated in FIGS. 17(A) and (B), the client device 30 can generate the post-change motion in which the bone B1 corresponding to the head of the object P1 is changed toward the user avatar UA1 as illustrated in FIG. 17(C) by the motion generation unit 306 and the motion control unit 307 (S133 to S138). Such post-change motion is generated on the basis of the change pattern II illustrated in FIG. 11. In this post-change motion, since the bone B1 of the head of the object P1 does not move unnaturally, that is, does not exceed the range of motion of the joint, a failure does not occur. In this case, the client device 30 may adopt the post-change motion.

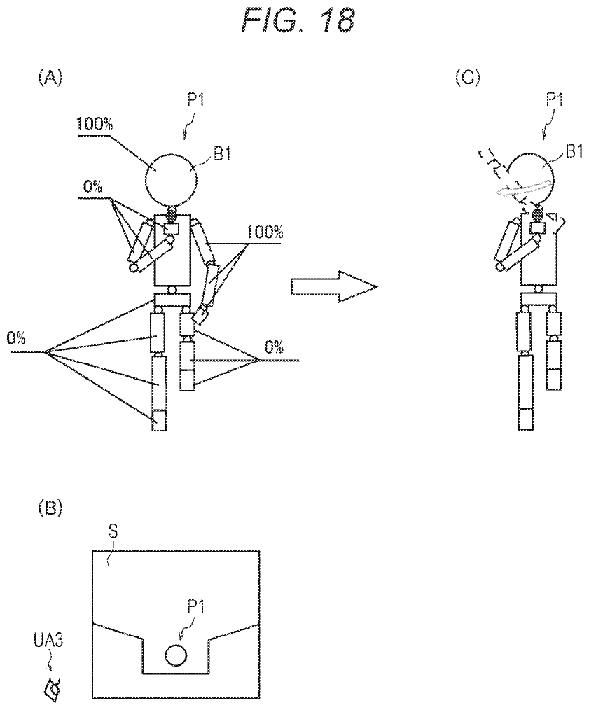

On the other hand, FIGS. 18(A) and 18(B) are the same situations as the situations illustrated in FIGS. 17(A) and 17(B), and in this case, it is assumed that the position of a user avatar UA3 is detected as illustrated in FIG. 18(B). In this case, the client device 30 attempts to generate the post-change motion in which the object P1 changes the bone B1 corresponding to the head toward the user avatar UA3 as illustrated in FIG. 18(C) by the motion generation unit 306 and the motion control unit 307 (S133 to S136). However, in this post-change motion, as understood from FIG. 18(C), the bone B1 of the object P1 moves unnaturally. That is, it exceeds the range of motion of the joint, and the failure occurs (NO in S137). In such a case, the client device 30 does not adopt the post-change motion.

### (Example 3) Change 2 of Head and Line-of-Sight

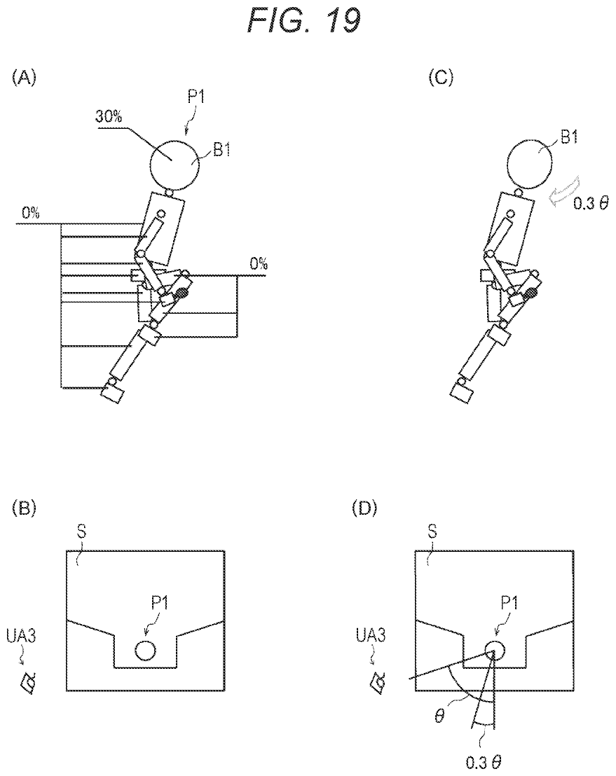

FIGS. 19(A) and (B) correspond to the states of FIGS. 6(A) to (C). That is, in FIGS. 19(A) and (B), the object P1 is dancing at the distal end of the stage S. At this time, the tolerance of the object P1 is 0% except for the bone B1 corresponding to the head.

In a case where the position and the line-of-sight of the user avatar UA3 are detected under the situation illustrated in FIGS. 19(A) and (B), the client device 30 can generate the post-change motion in which the bone B1 corresponding to the head of the object P1 is changed to the user avatar UA3 as illustrated in FIGS. 19(C) and (D) by the motion generation unit 306 and the motion control unit 307 (S133 to S138). Such post-change motion is generated on the basis of the change pattern II illustrated in FIG. 11. In this post-change motion, since the bone B1 of the head of the object P1 does not move unnaturally, that is, does not exceed the range of motion of the joint, a failure does not occur. In this case, the client device 30 may adopt the post-change motion.

Furthermore, in the post-change motion shown in FIGS. 19(C) and (D), the degree of change is adjusted by the tolerance. That is, since the tolerance of the bone B1 corresponding to the head is set to 30%, 30% of the change based on the change pattern II is set for the post-change motion. Specifically, in a case where 100% of the change based on the change pattern II is reflected, the bone B1 corresponding to the head moves at the angle θ as illustrated in FIG. 19(D), but since the tolerance of 30% is reflected, the change angle of the bone B1 corresponding to the head in the post-change motion is 0.3 θ.

### (Example 4) Change and Correction of Movement Paths of a Plurality of Objects

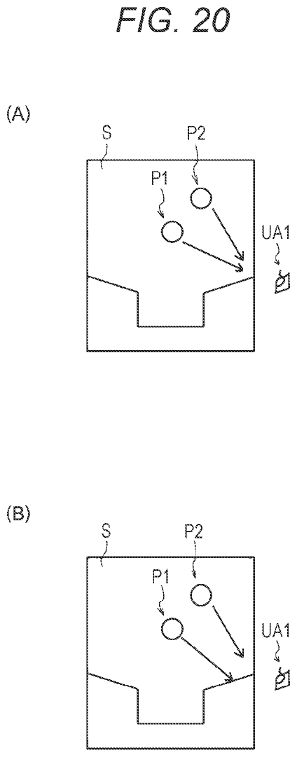

FIG. 20(A) illustrates a situation in which a plurality of objects P1 and P2 is located on the stage S. In such a case, the client device 30 can change the motions of the two plurality of objects P1 and P2 according to the information about recognition of the user. In FIG. 20, in the case of following the basic motion information, the objects P1 and P2 walk toward the front of the stage S as indicated by broken arrows.

In a case where the position of the user avatar UA1 is detected under the situation illustrated in FIG. 20(A), the client device 30 can generate the post-change motion corresponding to each of the objects P1 and P2 in which the objects P1 and P2 walk toward the user avatar UA1 as indicated by solid arrows in FIG. 20 by the motion generation unit 306 and the motion control unit 307 (S133 to S138). Such post-change motion is generated on the basis of the change pattern I illustrated in FIG. 11.

However, in the movement path of the post-change motion indicated by the solid arrow in FIG. 20(A), when the objects P1 and P2 are moved in each of the post-change motions, different objects P1 and P2 may interfere with each other. Therefore, in this example, the client device 30 corrects at least one of the post-change motions as illustrated in FIG. 20(B) (S139). In the corrected post-change motion, there is no interference between the objects P1 and P2, and no failure occurs. In this case, the client device 30 may adopt the post-change motion.

Note that the examples 1 to 4 described above are merely examples, and various motion changes different from the examples 1 to 4 can be performed in the present embodiment.

As described above, in the present embodiment, the motion of the object in the content can be changed on the basis of the information about recognition by the user viewing the content of the content. As a result, it is possible to secure the interactivity between the viewing state of the user and the content in a form of personalizing the user. Specifically, it is possible to simulate an interaction between an object as a performer and a user (user avatar) as an audience, and a reaction to what has happened between the two, and the user can obtain a sense of unity with the object as the performer and a premium feeling of experience. As a result, content with high added value can be provided.

Furthermore, in the present embodiment, the motion of the object in the content is changed by the client device 30 on the basis of the information about recognition of the content by the user detected by the client device 30. In this case, the load of the change in motion is borne by the client device 30. Therefore, a time lag due to processing delay or the like can be suppressed, and content can be provided for the user. That is, the motion of the object may be performed by the server device 20, but in this case, a delay is likely to occur until the change is reflected.

### <Modification of Content Display>

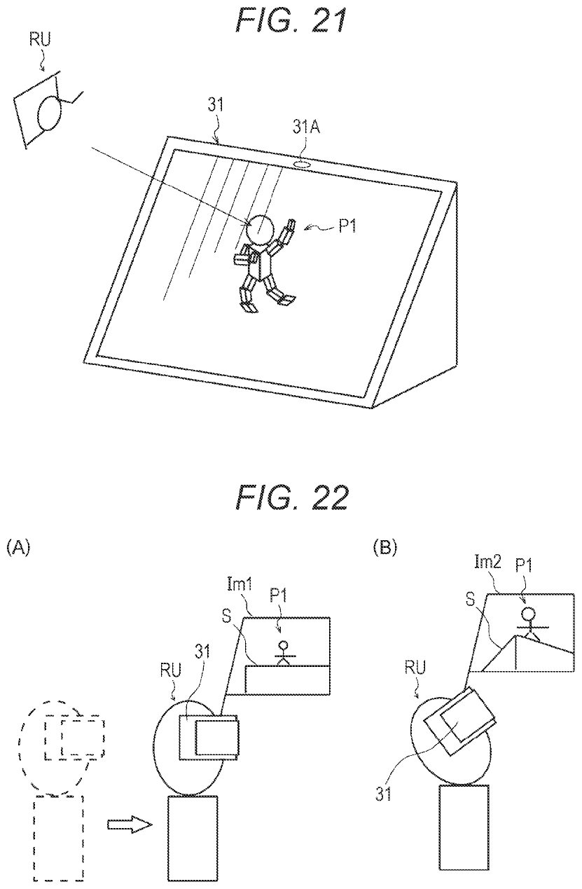

In the first embodiment described above, an example is described in which the display device 31 includes an LCD. FIG. 21 is a diagram illustrating a modification of the first embodiment using a spatial reproduction display as the display device 31. Reference numeral 31A in FIG. 21 denotes a sensor provided on an outer face of the display device 31 which is a spatial reproduction display. The sensor 31A may be an imaging device or the like. The display device 31 three-dimensionally displays the object P1. In this configuration, the sensor 31A can detect the position, the line-of-sight, and the gesture of a user RU viewing the object P1 (content), and can change the motion of the object P1 according to the detection.

FIG. 22 is a diagram illustrating a modification of the first embodiment using a head mounted display as the display device 31. As indicated by reference numeral Im1 in FIG. 22(A) and reference numeral Im2 in FIG. 22(B), content is displayed in a virtual space directly viewed by the user RU on the head mounted display. Reference numeral Im1 indicates a state in which the user visually recognizes the object P1 on the stage S from a position away from the stage S. Reference numeral Im2 indicates a state in which the user RU looks up the object P1 on the stage S from immediately below the stage S.

The head mounted display is provided with a gyro sensor and a line-of-sight detection sensor. As indicated by an arrow in FIG. 22(A), in a case where the user moves forward, movement is detected by the gyro sensor, and a virtual space is displayed so that the user approaches the stage S. Furthermore, as indicated by the arrow in FIG. 22(B), in a case where the user RU looks upward, the tilt of the head is detected by the gyro sensor, and the display of the virtual space is switched. In this configuration, the gyro sensor, the line-of-sight detection sensor, and the sensor attached to the arm or the like of the user RU can detect the position, the line-of-sight, and the gesture of the user RU, and the motion of the object P1 can be changed in response to the detection.

### Second Embodiment

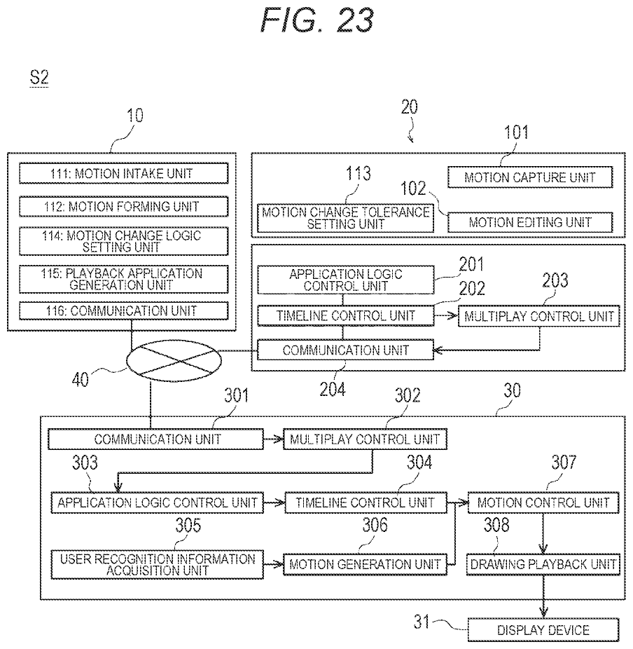

Hereinafter, an information processing system S2 according to the second embodiment will be described. FIG. 23 illustrates a block diagram of each of the content data distribution device 10, the server device 20, and the client device 30 constituting the information processing system S2 according to the second embodiment. Of the components in the second embodiment, the components similar to those in the first embodiment are denoted by the same reference numerals, and redundant description will be omitted.

The information processing system S2 according to the second embodiment provides the client device 30 with the acquired motion material via the server device 20 in real time. In order to realize such a configuration, as illustrated in FIG. 23, the server device 20 includes the motion capture unit 101, the motion editing unit 102, the motion change tolerance setting unit 113, the application logic control unit 201, the timeline control unit 202, the multiplay control unit 203, and the communication unit 204. The function of each unit is similar to that of the first embodiment.

On the other hand, unlike the configuration of the first embodiment in the content data distribution device 10, the motion capture unit 101, the motion editing unit 102, and the motion change tolerance setting unit 113 are not included. In addition, the configuration of the client device 30 is the same as the configuration of the first embodiment.

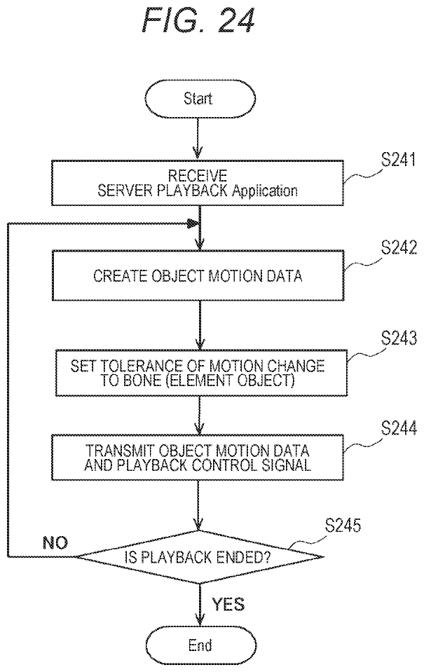

FIG. 24 is a flowchart illustrating an example of the operation of the server device 20 according to the second embodiment. In the second embodiment, after receiving the server playback application (data) (S241), the server device 20 creates object motion data (S242). The object motion data is created with the motion material acquired by the motion capture unit 101 through the motion editing unit 102, the application logic control unit 201, and the timeline control unit 202. Each of the application logic control unit 201 and the timeline control unit 202 analyzes the motion material acquired by the motion capture unit 101 to create motion information and motion playback speed information constituting the object motion data.

After the object motion data is created, the server device 20 sets the tolerance of the change in motion for the object whose motion is reproduced by the object motion data (S243). This setting is performed by the motion change tolerance setting unit 113.

Thereafter, the server device 20 processes a plurality of bones constituting the object motion data, body parts corresponding thereto, motion information for reproducing motions of the bones according to the real motion of the performer, playback speed information of the motion, and the like into a control signal and the like to transmit the control signal and the like to the client device 30 (S244). Then, when receiving the playback end signal, the server device 20 stops the transmission of the control signal, and ends the process (S245).

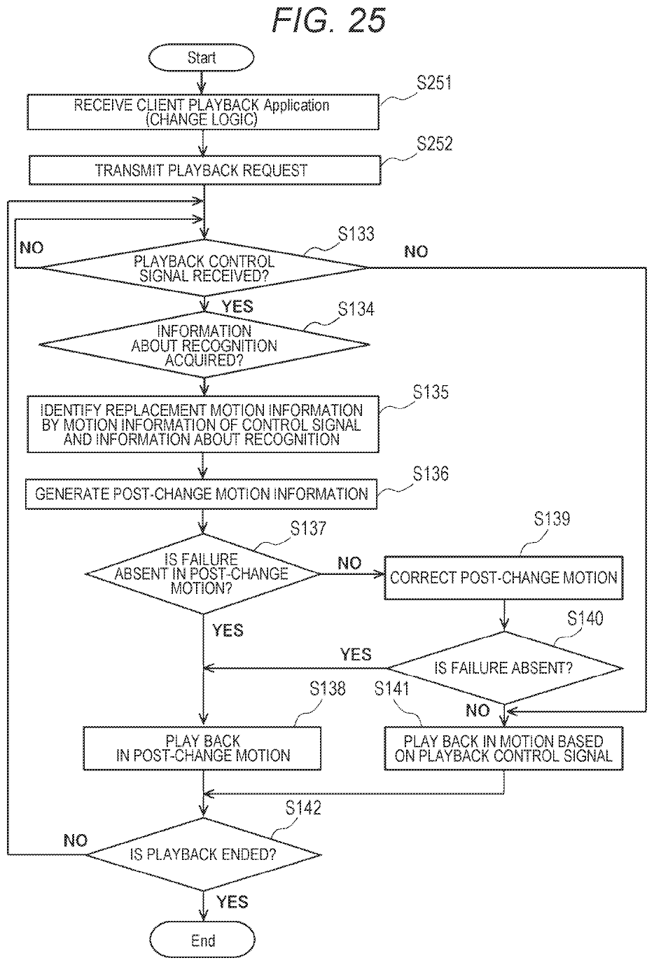

FIG. 25 illustrates an example of the operation of the client device 30 according to the second embodiment. As illustrated in FIG. 25, in the second embodiment, after receiving the client playback application (data) (S251) and transmitting a content playback request to the server device 20 (S252), the client device 30 waits for a control signal from the server device 20 (S133). The present embodiment is different from the first embodiment in that only the information about the client playback application and the motion change logic is received from the content data distribution device 10 in step S251. Steps S133 to S142, which are the subsequent processing, are similar to those in the first embodiment.

Also in the second embodiment described above, content with high added value can be provided.

### <<Hardware Configuration>>

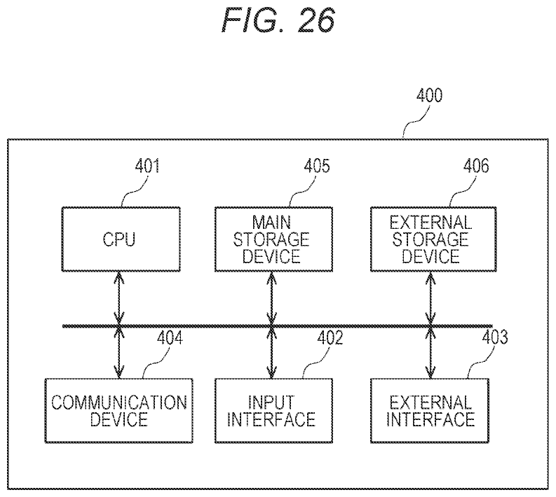

FIG. 26 illustrates an example of a hardware configuration of an information processing device 400 that can constitute the content data distribution device 10, the server device 20, and the client device 30 in each of the above-described embodiments. An information processing device 400 illustrated in FIG. 26 includes a CPU 401, an input interface 402, an external interface 403, a communication device 404, a main storage device 405, and an external storage device 406, which are mutually connected by a bus 407. The information processing device 400 is configured as, for example, a smartphone, a tablet, a desktop PC, or a notebook PC.

The central processing unit (CPU) 401 executes an information processing program, which is a computer program, on the main storage device 405. The information processing program is a program that realizes each function configuration of the information processing device 400. The information processing program may be realized not by one program but by a combination of a plurality of programs and scripts. The CPU 401 executes the information processing program to implement each function configuration.

The input interface 402 is a circuit for inputting operation signals from input devices such as a hand controller, a keyboard, a mouse, and a touch panel to the information processing device 400. The input interface 402 may include an imaging device such as a camera, and a sensor such as a time of flight (TOF) sensor, or light detection and ranging (LiDAR).

The external interface 403 outputs data or information to an external device such as an HMD, a liquid crystal display (LCD), an organic electroluminescence display, a cathode ray tube (CRT), or a plasma display (PDP).

The communication device 404 is a circuit for the information processing device 400 to communicate with an external device by wire or wirelessly. The data can be input from an external device via the communication device 404. Data input from the external device can be stored in the main storage device 405 or the external storage device 406.

The main storage device 405 stores an information processing program, data necessary for execution of the information processing program, data generated by execution of the information processing program, and the like. The information processing program is developed and executed on the main storage device 405. The main storage device 405 is, for example, a RAM, a DRAM, or an SRAM, but is not limited thereto.

The external storage device 406 stores an information processing program, data necessary for execution of the information processing program, data generated by execution of the information processing program, and the like. The information processing program and the data are read out to the main storage device 405 when the information processing program is executed. Examples of the external storage device 406 include a hard disk, an optical disk, a flash memory, and a magnetic tape, but are not limited thereto.

Note that the information processing program may be installed in advance in the information processing device 400 or may be stored in a storage medium such as a CD-ROM. Furthermore, the information processing program may be uploaded on the Internet.

Furthermore, the information processing device 400 may be configured by a single information processing device, or may be configured as a system including a plurality of information processing devices connected to each other.

Note that the embodiment described above has described examples for embodying the present disclosure, and the present disclosure can be implemented in various other forms. For example, various modifications, replacements, omissions, or combinations thereof can be made without departing from the gist of the present disclosure. Forms in which such modifications, replacements, omissions, and the like have been made are also included in the scope of the present disclosure and are likewise included in the invention described in the claims and the equivalent scopes thereof.

Furthermore, the effects of the present disclosure described in the present specification are mere examples, and other effects may be provided.

Note that the present disclosure can have the following configurations.

[Item 1]

An information processing device including a motion control unit configured to change, on the basis of information about recognition by a user viewing content of the content, a motion of an object in the content.

[Item 2]

The information processing device according to Item 1, in which the motion control unit changes the motion on the basis of motion change logic that defines a relationship between the information about recognition and a change pattern of the motion.

[Item 3]

The information processing device according to Item 2,
in which a priority is defined to the change pattern, and
in a case where a plurality of the change patterns corresponding to the information about recognition is selectable, the motion control unit selects the change pattern on the basis of the priority.

[Item 4]

The information processing device according to any one of Items 1 to 3,
in which a tolerance regarding a change in the motion by the motion control unit is defined in the object, and
the motion control unit changes a degree of changing the motion or does not change the motion according to the tolerance.

[Item 5]

The information processing device according to Item 4, in which the tolerance is set to a different value according to a detail of the motion.

[Item 6]

The information processing device according to Item 4 or 5,
in which the object includes a plurality of element objects,
the motion is configured by a combination of element motions set for the respective element objects, and
the tolerance is defined for each of the element objects as a tolerance regarding a change in the element motion.

[Item 7]

The information processing device according to Item 6, in which the element object that changes the element motion is selected on the basis of the tolerance defined for each of the element objects, and the motion control unit changes the element motion corresponding to the selected element object to change the motion.

[Item 8]

The information processing device according to Item 6 or 7,
in which a plurality of the element objects is connected via joints, and
the element motion includes a motion in which the element object relatively changes a posture with respect to the corresponding joint and/or a motion in which a state of each of the element objects changes.

[Item 9]

The information processing device according to any one of Items 1 to 8, in which when changing the motion, the motion control unit determines whether or not a post-change motion after changing the motion exceeds a predetermined allowable motion range.

[Item 10]

The information processing device according to Item 9, in which the motion control unit does not change the motion in a case where it is determined that the post-change motion exceeds the allowable motion range.

[Item 11]

The information processing device according to Item 9, in which the motion control unit corrects the post-change motion in a case where it is determined that the post-change motion exceeds the allowable motion range.

[Item 12]

The information processing device according to any one of Items 1 to 11, in which when a motion of each of a plurality of the objects is changed and a plurality of the objects is moved in respective post-change motions after changing motions of the respective objects, the motion control unit corrects, in a case where the objects that are different interfere with each other, at least one of the post-change motions of the different objects.

[Item 13]

The information processing device according to any one of Items 1 to 12, in which the content is displayed in a virtual space in which an avatar operated by the user exists.

[Item 14]

The information processing device according to Item 13, in which the information about recognition includes information about a relative position between the avatar and the object in the virtual space.

[Item 15]

The information processing device according to any one of items 1 to 12, in which the content is displayed on a display device visually recognized by the user.

[Item 16]

The information processing device according to Item 15, in which the information about recognition includes information about a direction of a line-of-sight of the user with respect to the display device.

[Item 17]

The information processing device according to Item 15,
in which the display device includes a head mounted display, and
the information about recognition includes at least one of pieces of information about a posture, a position, or a direction of the head mounted display.

[Item 18]

An information processing method including
acquiring information about recognition by a user viewing content of the content, and
changing a motion of an object in the content on the basis of the information about recognition.

[Item 19]

An information processing system including
a server device and a client device that plays back content under control of the server device,
in which at least one of the server device or the client device includes a motion control unit that changes a motion of an object in the content on the basis of information about recognition by a user viewing the content with the client device of the content.

[Item 20]

A computer program for causing a computer to execute a step of changing a motion of an object in content on the basis of information about recognition by a user viewing the content of the content.

[Item 21]

A computer-readable recording medium recording a computer program for causing a computer to execute a step of changing a motion of an object in content on the basis of information about recognition by a user viewing the content of the content.

### REFERENCE SIGNS LIST

S1, S2 Information processing system
10 Content data distribution device
100 Motion material acquisition unit
101 Motion capture unit
102 Motion editing unit
110 Motion data generation unit
111 Motion intake unit
112 Motion forming unit
113 Motion change tolerance setting unit
114 Motion change logic setting unit
115 Playback application generation unit
116 Communication unit
20 Server device
201 Application logic control unit
202 Timeline control unit
203 Multiplay control unit
204 Communication unit
30 Client device
301 Communication unit
302 Multiplay control unit
303 Application logic control unit
304 Timeline control unit
305 User recognition information acquisition unit
306 Motion generation unit
307 Motion control unit
308 Drawing playback unit
40 Communication network
400 Information processing device
401 CPU
402 Input interface
403 External interface
404 Communication device
405 Main storage device
406 External storage device
407 Bus
P Performer
P1 Object
UA1 to 4 User avatar

1. An information processing device comprising: a motion control unit configured to change, on a basis of information about recognition by a user viewing content of the content, a motion of an object in the content.

2. The information processing device according to claim 1, wherein the motion control unit changes the motion on a basis of motion change logic that defines a relationship between the information about recognition and a change pattern of the motion.

3. The information processing device according to claim 2,
wherein a priority is defined to the change pattern, and
in a case where a plurality of the change patterns corresponding to the information about recognition is selectable, the motion control unit selects the change pattern on a basis of the priority.

4. The information processing device according to claim 1,
wherein a tolerance regarding a change in the motion by the motion control unit is defined in the object, and
the motion control unit changes a degree of changing the motion or does not change the motion according to the tolerance.

5. The information processing device according to claim 4, wherein the tolerance is set to a different value according to a detail of the motion.

6. The information processing device according to claim 4,
wherein the object includes a plurality of element objects,
the motion is configured by a combination of element motions set for the respective element objects, and
the tolerance is defined for each of the element objects as a tolerance regarding a change in the element motion.

7. The information processing device according to claim 6, wherein the element object that changes the element motion is selected on a basis of the tolerance defined for each of the element objects, and the motion control unit changes the element motion corresponding to the selected element object to change the motion.

8. The information processing device according to claim 6,
wherein a plurality of the element objects is connected via joints, and
the element motion includes a motion in which the element object relatively changes a posture with respect to the corresponding joint and/or a motion in which a state of each of the element objects changes.

9. The information processing device according to claim 1, wherein when changing the motion, the motion control unit determines whether or not a post-change motion after changing the motion exceeds a predetermined allowable motion range.

10. The information processing device according to claim 9, wherein the motion control unit does not change the motion in a case where it is determined that the post-change motion exceeds the allowable motion range.

11. The information processing device according to claim 9, wherein the motion control unit corrects the post-change motion in a case where it is determined that the post-change motion exceeds the allowable motion range.

12. The information processing device according to claim 1, wherein when a motion of each of a plurality of the objects is changed and a plurality of the objects is moved in respective post-change motions after changing motions of the respective objects, the motion control unit corrects, in a case where the objects that are different interfere with each other, at least one of the post-change motions of the different objects.

13. The information processing device according to claim 1, wherein the content is displayed in a virtual space in which an avatar operated by the user exists.

14. The information processing device according to claim 13, wherein the information about recognition includes information about a relative position between the avatar and the object in the virtual space.

15. The information processing device according to claim 1, wherein the content is displayed on a display device visually recognized by the user.

16. The information processing device according to claim 15, wherein the information about recognition includes information about a direction of a line-of-sight of the user with respect to the display device.

17. The information processing device according to claim 15,
wherein the display device includes a head mounted display, and
the information about recognition includes at least one of pieces of information about a posture, a position, or a direction of the head mounted display.

18. An information processing method comprising:
acquiring information about recognition by a user viewing content of the content; and
changing a motion of an object in the content on a basis of the information about recognition.

19. An information processing system comprising:
a server device and a client device that plays back content under control of the server device,
wherein at least one of the server device or the client device includes a motion control unit that changes a motion of an object in the content on a basis of information about recognition by a user viewing the content with the client device of the content.

20. A computer program for causing a computer to execute a step of changing a motion of an object in content on a basis of information about recognition by a user viewing the content of the content.

21. A computer-readable recording medium recording a computer program for causing a computer to execute a step of changing a motion of an object in content on a basis of information about recognition by a user viewing the content of the content.
